(19) United States
(12) Patent Application Publication
(10) Pub. No.: US 2006/0223384 A1
(43) Pub. Date: Oct. 5, 2006

(54) Battery terminal clamp

(76) Inventor: Anthony E. Schuh, Marshall, TX (US)

Correspondence Address: LAW OFFICE OF TIMOTHY M. BARLOW, P.O. BOX 523272, SPRINGFIELD, VA, 22152, US

(21) Appl. No.: 11/095,629

(22) Filed: Mar. 31, 2005

(51) Int. Cl. H01R 4/48

(52) U.S. Cl. 439/759

(57) ABSTRACT

A battery terminal clamp includes a pair of spring-loaded lever arms pivotally joined at a pivot. Each lever arm includes a handle end and a jaw end. At least one of the jaw ends has an engagement aperture for clamping onto a battery terminal. The aperture is a keyway or a fork for engaging a circumferential groove around a battery terminal. The aperture may include a relief slot for additional flex. In another embodiment, the spring-loaded battery terminal clamp is eliminated, so that only a substantially flat electrical conductor remains. The electrical conductor includes the engagement aperture near a first end and a connection for a flexible conductor at a second end. Thus, a pair of jumper cables can be manufactured where the jumper cables include no moving parts.

### BACKGROUND OF THE INVENTION

1. Field of the Invention

The present invention relates to a battery terminal clamp. In particular, the present invention relates to a battery terminal clamp that positively and securely fastens to the terminal bolts found on typical side-post and top-post batteries.

2. Description of the Related Art

There are many varieties of battery terminal clamps on the market today. The vast majority of these battery terminal clamps include numerous interconnected moving parts. Most of these battery terminal clamps are spring-loaded clamps with jaws that clamp onto a battery terminal. Some of these spring-loaded clamps have attachments for attaching to a battery terminal clamp. However, each of these attachments creates more problems than they solve. The attachments are invariably movable on and removable from the spring-loaded clamps. They add further complexity and expense to the manufacturing process and raise the retail price to the consumer. The movable and removable nature of these attachments also increases the likelihood that they will become broken or lost by the consumer in ordinary use.

In addition, the fact that the attachments are movable means that the battery clamp circuit is compromised with additional joints. Each additional joint that connects the parts in an electrical circuit are additional places where oxidation and dirt can accumulate, reducing or even preventing electric current flow. The only reason most people have these battery terminal clamps is to jump a dead car battery. However, if the circuit is compromised with moving parts and dirt or oxidation, the clamps are worthless.

Therefore, there has been and continues to be a need for a battery terminal clamp that attaches quickly and securely to virtually every side-post and top-post battery terminal, without additional moving parts or without any moving parts at all, eliminating electric circuit compromises and greatly improving the reliability of the clamps.

### SUMMARY OF THE DISCLOSURE

A battery terminal clamp includes a pair of spring-loaded lever arms pivotally joined at a pivot. Each lever arm includes a handle end and a jaw end. At least one of the jaw ends has an engagement aperture for clamping onto a battery terminal. The engagement aperture may be a keyway and may further include a relief slot to permit the engagement aperture to flex as it engages a circumferential groove around a battery terminal bolt. The spring-loaded lever arms and pivot may be eliminated to provide a battery terminal clamp that is simply a substantially flat electrical conductor having an engagement aperture or engagement fork near a first end and a connection for a flexible conductor at a second end. A pair of these flat electrical conductors at each end of a pair of electric cables would make a set of jumper cables suitable for automotive use.

It is therefore an object of the present invention to provide a battery terminal clamp that requires no moving parts.

It is another object of the present invention to provide a battery terminal clamp that requires no new moving parts, when incorporated into a typical spring-loaded battery clamp.

It is another object of the present invention to teach a battery terminal clamp that adds no new parts to a standard spring-loaded battery terminal clamp.

It is another object of the present invention to teach a battery terminal clamp that creates no additional electrical connections through a standard spring-loaded battery terminal clamp.

It is another object of the present invention to provide a battery terminal clamp that offers reduced complexity when compared with standard spring-loaded battery terminal clamps.

It is another object of the present invention to provide a battery terminal clamp that offers reduced manufacturing costs when compared with standard spring-loaded battery terminal clamps.

It is another object of the present invention to provide a battery terminal clamp that works on both side-terminal and top-terminal batteries.

It is another object of the present invention to provide a battery terminal clamp that eliminates spring-loaded battery terminal clamps.

It is another object of the present invention to provide a battery terminal clamp that is easier to package and store than standard spring-loaded battery terminal clamps.

Finally, it is an object of the present invention to accomplish the foregoing objectives in a simple and cost effective manner.

### BRIEF DESCRIPTION OF THE DRAWINGS

FIG. 1 is a perspective view of a battery terminal clamp, in accordance with the present invention;

FIG. 2 is an exploded perspective view of the battery terminal clamp, in accordance with the present invention;

FIG. 3 is a perspective view of the battery terminal clamp, in accordance with the present invention; and

FIG. 4 is a perspective view of the battery terminal clamp, in accordance with the present invention.

### DETAILED DESCRIPTION OF THE DRAWINGS

The following detailed description is of the best presently contemplated modes of carrying out the invention. This description is not to be taken in a limiting sense, but is made merely for the purpose of illustrating general principles of embodiments of the invention.

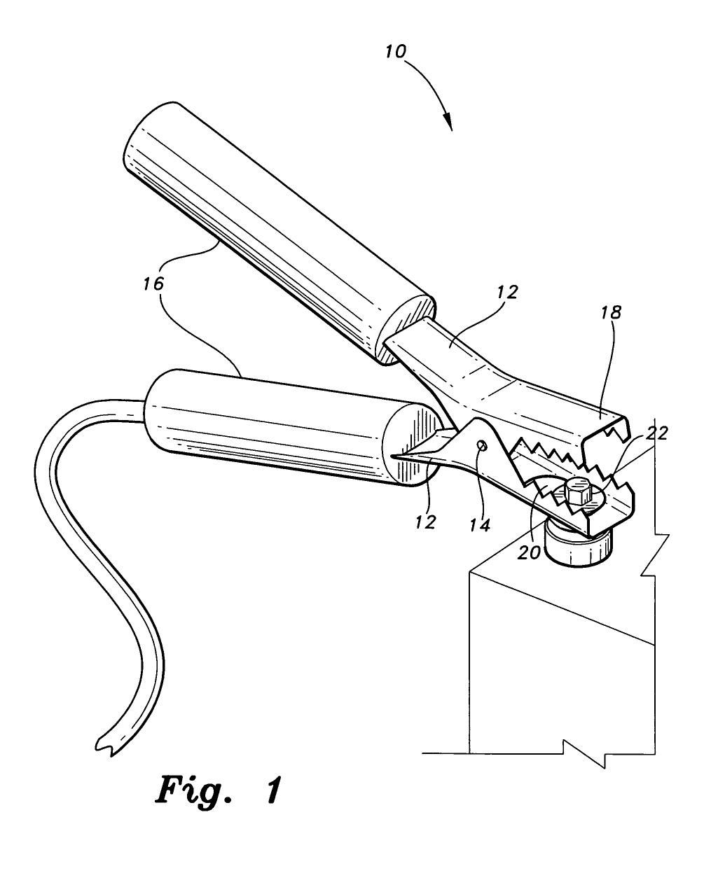

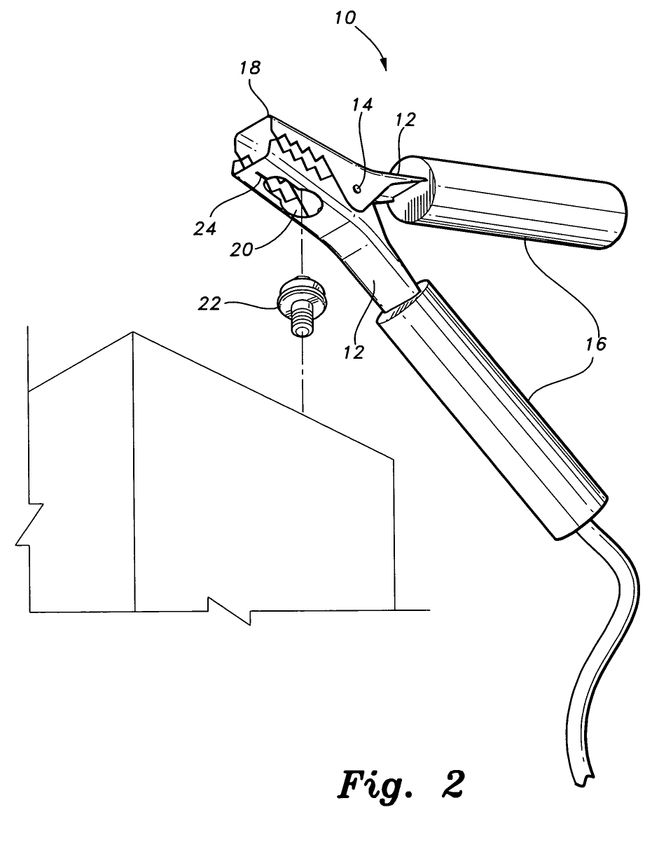

FIGS. 1 and 2 show a battery terminal clamp 10 that includes a pair of spring-loaded lever arms 12 pivotally joined at a pivot 14. Each lever arm includes a handle end 16 and a jaw end 18. The jaw end 18 includes an engagement aperture 20 for clamping onto a battery terminal 22. The engagement aperture 20 may be a keyhole having a generally oblong shape with a large aperture and a small aperture merged into one. The large aperture provides clearance for a battery terminal 22 to pass through the engagement aperture 20. The small aperture end of the engagement aperture 20 is then moved into engagement with the battery terminal 22. Typical side-post and top-post batteries use a bolt to hold a set of cables securely to the battery. These bolts have a circumferential groove on a flange below a hex head. The engagement aperture 20 of the battery terminal clamp engages this circumferential groove around the battery terminal bolt. The battery terminal 22 bolts are manufactured to standard dimensions, thus the dimensions of the engagement aperture 20 are easily determined. Thus the small end of the engagement aperture 20 is in direct contact with at least half of the circumference of the battery terminal 22 bolt.

The battery terminal clamp 10 is made from a material that has a very high ability to conduct electricity, such as copper. Typical materials with such conduction properties are metals that are both malleable and ductile. The materials make manufacturing relatively easy and provide the benefit of being somewhat self-adjusting. For example, the engagement aperture 20 may be formed so that it is just a little too small for an exact fit. The inherent flexibility of the material will the permit the user to gently force the engagement aperture 20 onto the battery terminal 22 bolt for a very snug fit, ensuring maximum surface area contact and conduction capability. In another embodiment, the engagement aperture further includes a relief slot 24 integrally formed with the engagement slot 20. The relief slot 24 is at an end of the small aperture of the engagement aperture 20, opposite from the large aperture. The relief slot 24 offers additional flex to the engagement aperture 20 as well as easy adjustment by the user. As the engagement aperture 20 is used repeatedly, over time it may stretch and create a looser fit onto a battery terminal 22 bolt. The engagement aperture 20 may be adjusted to be narrower with a simple pair of pliers or a similar tool, by gently squeezing the sides of the engagement aperture 20 together.

This battery terminal clamp 10 offers the advantage of having no additional moving parts as compared with standard battery terminal clamps. No moving parts means no parts to lose and no joints or connections to corrode or loosen and compromise the electric circuit, such as when jumping a dead battery. No moving parts also means reduces complexity and costs for manufacturing.

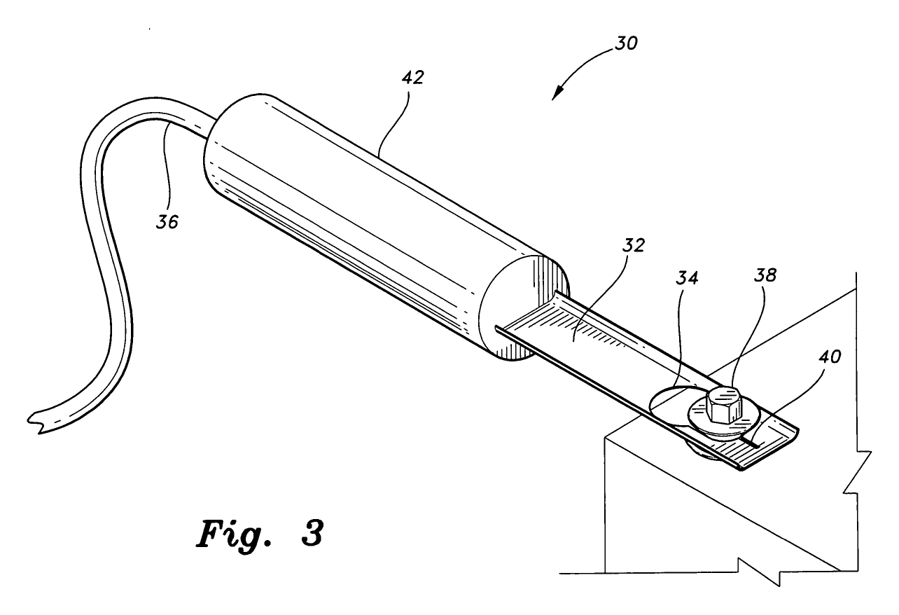

FIG. 3 shows an alternative embodiment of a battery terminal clamp. The battery terminal clamp 30 is a substantially flat electrical conductor 32 that has an engagement aperture 34 near a first end and a connection for a flexible conductor 36, such as an electric cable, at a second end. The engagement aperture 34 is a keyhole, as described in FIGS. 1 and 2 above. The keyhole-shaped engagement aperture 34 engages a circumferential groove around a battery terminal bolt 38. The engagement aperture may further include a relief slot 40 to provide additional flex and adjustment for the engagement aperture 34.

The second end of the conductor 32 may be covered with an electrically insulating material to form a handle 42. The insulating material may be a rubber, plastic or other nonconductive coating or covering to make the conductor easier to grasp and handle, and to reduce the likelihood of short-circuit.

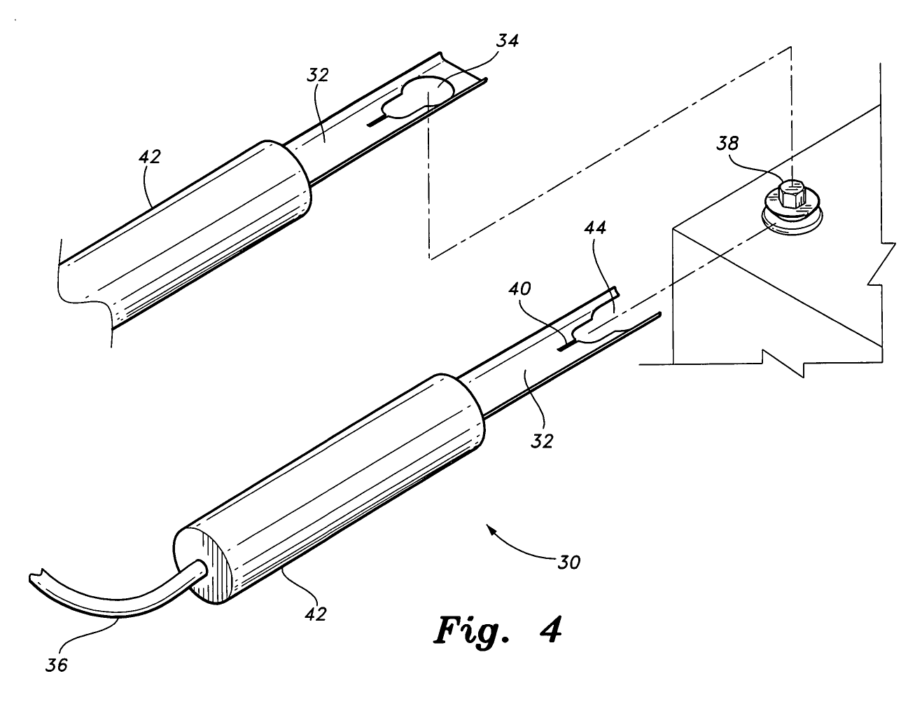

FIG. 4 shows another embodiment, where the electrical conductor 32 does not have an enclosed engagement aperture 34, but instead has an engagement fork 44 at the terminus of the first end of the conductor 32. The engagement fork 44 is the same generally keyhole-shaped feature as describe above, but the large end of the engagement fork 44 is at the edge of the conductor 32 and is open. The smaller end of the engagement fork 44 is inset. Thus, the user needs only to push the engagement fork 44 onto a battery terminal bolt 38. As above, the engagement fork 44 engages a circumferential groove around the battery terminal bolt 38. A relief slot 40 may be incorporated into the small end of the engagement fork 44.

In this manner, the battery terminal clamp 30 requires no moving parts, and is easy and inexpensive to manufacture. Further, the clamp 30 eliminates spring-loaded battery terminal clamps and is easier to package and store than standard spring-loaded battery terminal clamps.

While the description above refers to particular embodiments of the present invention, it will be understood that many modifications may be made without departing from the spirit thereof. The accompanying claims are intended to cover such modifications as would fall within the true scope and spirit of the present invention. While the description above refers to particular embodiments of the present invention, it will be understood that many modifications may be made without departing from the spirit thereof. The accompanying claims are intended to cover such modifications as would fall within the true scope and spirit of the present invention.

### PART NUMBERS

10 battery terminal clamp
12 spring-loaded lever arms
14 pivot
16 handle
18 jaw
20 engagement aperture
22 battery terminal
24 relief slot
30 battery terminal clamp (flat one)
32 flat electrical conductor
34 engagement aperture
36 flexible conductor (power cable)
38 battery terminal bolt
40 relief slot
42 handle
44 engagement fork

1. A battery terminal clamp, comprising:
a pair of spring-loaded lever arms pivotally joined at a pivot, where each lever arm comprises
a handle end; and
a jaw end, where the jaw end comprises an engagement aperture for clamping onto a battery terminal.

2. The battery terminal clamp of claim 1, where the aperture is a keyhole.

3. The battery terminal clamp of claim 1, where the aperture engages a circumferential groove around a battery terminal bolt.

4. The battery terminal clamp of claim 1, where the aperture comprises a relief slot.

5. A battery terminal clamp, comprising:
a substantially flat electrical conductor having an engagement aperture integrally formed with the flat electrical conductor near a first end of the flat electrical conductor and a connection for a flexible conductor at a second end of the flat electrical conductor.

6. The battery terminal clamp of claim 5, where the aperture is a keyhole.

7. The battery terminal clamp of claim 5, where the aperture engages a circumferential groove around a battery terminal bolt.

8. The battery terminal clamp of claim 5, where the aperture further comprises a relief slot.

9. The battery terminal clamp of claim 5, where the second end of the substantially flat electrical conductor is covered with an electrically insulating material.

10. A battery terminal clamp, comprising:
a substantially flat electrical conductor having a modified engagement aperture integrally formed into the substantially flat electrical conductor at a first end and a connection for a flexible conductor at a second end.

11. The battery terminal clamp of claim 10, where the modified engagement aperture is a fork.

12. The battery terminal clamp of claim 10, where the modified engagement aperture engages a circumferential groove around a battery terminal bolt.

13. The battery terminal clamp of claim 10, where the modified engagement aperture further comprises a relief slot.

14. The battery terminal clamp of claim 10, where the second end of the substantially flat electrical conductor is covered with a nonconductive material.

15. A battery terminal clamp, comprising:
a conductor, the conductor comprising a handle end; and
an engagement end, where the engagement end comprises an integrally formed engagement aperture for attachment to a battery terminal.

16. The battery terminal clamp of claim 15 where the conductor is one of a pair of spring-loaded lever arms pivotally joined at a pivot, where each lever arm comprises
a handle end; and
at least one of the lever arms comprises an engagement end, where the engagement end comprises an engagement aperture for clamping onto a battery terminal.

17. The battery terminal clamp of claim 16, where the aperture is a keyhole.

18. The battery terminal clamp of claim 16, where the aperture engages a circumferential groove around a battery terminal bolt.

19. The battery terminal clamp of claim 16, where the aperture comprises a relief slot.
